(19) United States
(12) Patent Application Publication
(10) Pub. No.: US 2022/0051202 A1
(43) Pub. Date: Feb. 17, 2022

(54) PAYMENT ACCOUNT

(71) Applicant: TRANSCARD, LLC, Chattanooga, TN (US)

(72) Inventors: Greg Bloh, Chattanooga, TN (US); Christopher Fuller, Chattanooga, TN (US); Mark Patterson, Oak Ridge, TN (US); David Samples, Cleveland, TN (US)

(21) Appl. No.: 17/316,128

(22) Filed: May 10, 2021

Related U.S. Application Data
(63) Continuation of application No. 14/865,908, filed on Sep. 25, 2015, now abandoned.
(60) Provisional application No. 62/056,226, filed on Sep. 26, 2014.

(51) Int. Cl. G06Q 20/10; G06Q 20/28

(52) U.S. Cl. CPC G06Q 20/10; G06Q 20/28

(57) ABSTRACT

A system comprising a payment account generated by the payor and adapted to receive the payment from the payor and transfer the payment to the payee in at least one form of payment, a funding account to provide funds to a fund holding account which is adapted to provide the payment to the payment account, a payment processor to process the payment from the payor to the payment account and process the payment from the payment account to the payee, and a payee portal to be accessed by the payee and receive the payment from the payment account. The payment account is a dedicated account for only the payee, and the payee self-directs the transfer of funds and controls the form of payment made from the payment account. A method further comprising generating a payment account, providing funds to the payment account, and self-directing funds from the payment account.

### CROSS-REFERENCES TO RELATED APPLICATIONS/PATENTS

This application relates back to and claims the benefit of priority from U.S. Provisional Application for Patent No. 62/056,226 entitled “Payment Account” and filed on Sep. 26, 2014.

### FIELD OF THE INVENTION

The present invention relates generally to systems and methods for payment transactions from a payor to a payee, and particularly to payment transactions in which the payor generates a payment account and the payee self-directs the payment from the payment account.

### BACKGROUND AND DESCRIPTION OF THE PRIOR ART

It is known to use a variety of systems and processes to transfer a payment from a payor to a payee. Conventional systems and processes, however, suffer from one or more disadvantages. For example, conventional systems and processes require the payee to generate an account prior to receiving a payment from the payor and require the payor to direct payments to the account that the payee previously generated. As a result, conventional systems and processes for transferring a payment from a payor to a payee require the payee to provide the payor with sensitive information the payee may not want to provide (e.g. payee's Social Security No.) or information that must be updated from time to time (e.g. payee's residential address). Further, conventional systems and processes require the payor to collect an undesirably burdensome amount of routing and account information from the payee in order to make a payment to the payee's account. In addition, conventional systems and processes undesirably limit the payee's ability to receive a payment from a payor based on the payee's ability to access the designated account, and the payee is not permitted to self-direct the payment. Conventional systems and processes for transferring a payment from a payor to a payee also undesirably limit the form of payment the payee may receive. Further, conventional systems and processes for transferring a payment from a payor to a payee do not allow the payor to generate a payment account for each payee. Still further, conventional systems and processes for transferring a payment from a payor to a payee are insufficiently transparent with respect to the transaction history of the payment and the spending patterns of the payee. Conventional systems and processes for transferring a payment from a payor to a payee also result in cash flow and reconciliation difficulties. Additionally, conventional systems and processes for transferring a payment from a payor to a payee are undesirably expensive and slow and do not generate revenue for the payor.

It would be desirable, therefore, if a system and method for a payment transaction could be provided that would not require a payee to generate an account prior to receiving a payment from a payor or require the payor to direct payments to the account that the payee previously generated. It would also be desirable if such a system and method for a payment transaction could be provided that would not require the payee to provide the payor with sensitive information the payee may not want to provide (e.g. payee's Social Security No.) or information that must be updated from time to time (e.g. payee's residential address). It would be further desirable if such a system and method for a payment transaction could be provided that would not require the payor to collect an undesirably burdensome amount of routing and account information from the payee in order to make a payment to the payee's account. It would be still further desirable if such a system and method for a payment transaction could be provided that would not limit the payee's ability to receive a payment from a payor based on the payee's ability to access the designated account and would permit the payee to self-direct the payment.

In addition, it would be desirable if such a system and method for a payment transaction could be provided that would not limit the form of payment the payee may receive. It would also be desirable if such a system and method for a payment transaction could be provided that would allow the payor to generate a payment account for each payee. It would be further desirable if such a system and method for a payment transaction could be provided that would be sufficiently transparent with respect to the transaction history of the payment and the spending patterns of the payee. It would be still further desirable if such a system and method for a payment transaction could be provided that would minimize or eliminate cash flow and reconciliation difficulties. Additionally, it would be desirable if such a system and method for a payment transaction could be provided that would be less expensive and faster and generate revenue for the payor.

### ADVANTAGES OF THE PREFERRED EMBODIMENTS OF THE INVENTION

Accordingly, it is an advantage of the preferred embodiments of the invention claimed herein to provide a system and method for a payment transaction that does not require a payee to generate an account prior to receiving a payment from a payor or require the payor to direct payments to the account that the payee previously generated. It is also an advantage of the preferred embodiments of the invention claimed herein to provide a system and method for a payment transaction that does not require the payee to provide the payor with sensitive information the payee may not want to provide (e.g. payee's Social Security No.) or information that must be updated from time to time (e.g. payee's residential address). It is another advantage of the preferred embodiments of the invention claimed herein to provide a system and method for a payment transaction that does not require the payor to collect an undesirably burdensome amount of routing and account information from the payee in order to make a payment to the payee's account. It is still another advantage of the preferred embodiments of the invention claimed herein to provide a system and method for a payment transaction that does not limit the payee's ability to receive a payment from a payor based on the payee's ability to access the designated account and permits the payee to self-direct the payment. It is yet another advantage of the preferred embodiments of the invention claimed herein to provide a system and method for a payment transaction that does not limit the form of payment the payee may receive. In addition, it is an advantage of the preferred embodiments of the invention claimed herein to provide a system and method for a payment transaction that allows the payor to generate a payment account for each payee. It is also an advantage of the preferred embodiments of the invention claimed herein to provide a system and method for a payment transaction that is transparent with respect to the transaction history of the payment and the spending patterns of the payee. It is a further advantage of the preferred embodiments of the invention claimed herein to provide a system and method for a payment transaction that minimizes or eliminates cash flow and reconciliation difficulties. It is a still further advantage of the preferred embodiments of the invention claimed herein to provide a system and method for a payment transaction that is less expensive and faster and generates revenue for the payor.

Additional advantages of the preferred embodiments of the invention will become apparent from an examination of the drawings and the ensuing description.

### SUMMARY OF THE INVENTION

The system of the invention comprises a system for facilitating a payment from a payor to a payee. The preferred system comprises a payment account that is generated by the payor and adapted to receive the payment from the payor and transfer the payment to the payee in at least one form of payment, a funding account that is adapted to provide funds to a fund holding account which is adapted to provide the payment to the payment account, a payment processor that is adapted to process the payment from the payor to the payment account and process the payment from the payment account to the payee, and a payee portal that is adapted to be accessed by the payee and receive the payment from the payment account. In the preferred system, the payment account is a dedicated account for only the payee, and the payee self-directs the transfer of funds from the payment account and controls the form of payment made from the payment account.

The method of the invention comprises a method for facilitating a payment from a payor to a payee. The preferred method comprises providing a system for facilitating a payment from a payor to a payee. The preferred system comprises a payment account that is generated by the payor and adapted to receive the payment from the payor and transfer the payment to the payee in at least one form of payment, a funding account that is adapted to provide funds to a fund holding account which is adapted to provide the payment to the payment account, a payment processor that is adapted to process the payment from the payor to the payment account and process the payment from the payment account to the payee, and a payee portal that is adapted to be accessed by the payee and receive the payment from the payment account. In the preferred system, the payment account is a dedicated account for only the payee, and the payee self-directs the transfer of funds from the payment account and controls the form of payment made from the payment account. The preferred method also comprises generating a payment account, providing funds to the payment account, and self-directing funds from the payment account.

### BRIEF DESCRIPTION OF THE DRAWINGS

The presently preferred embodiments of the invention are illustrated in the accompanying drawing, in which like reference numerals represent like parts throughout, and in which:

FIG. 1 is a flow chart of the preferred embodiment of the system and method for a payment transaction in accordance with the present invention.

### DESCRIPTION OF THE PREFERRED EMBODIMENTS OF THE INVENTION

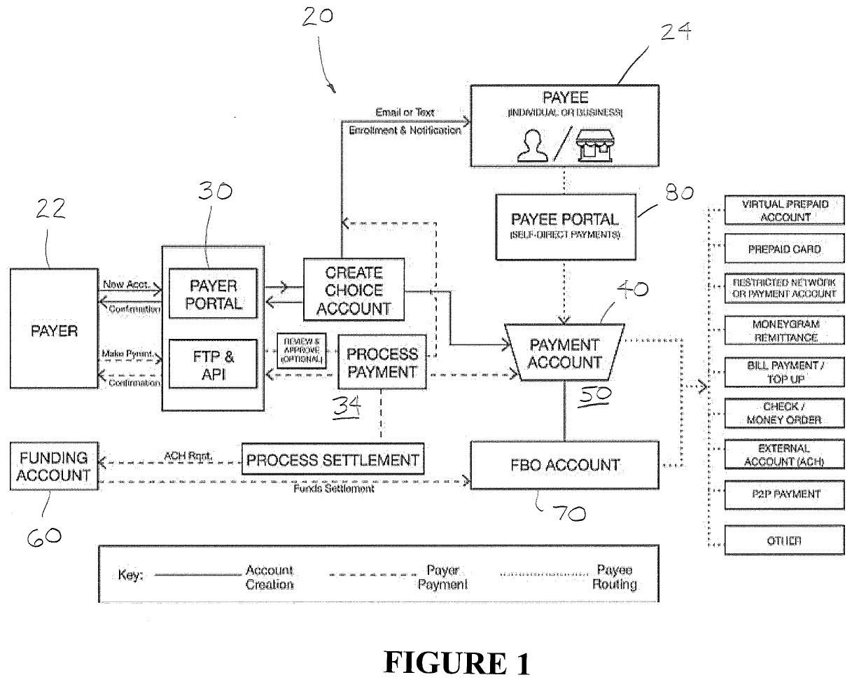

Referring now to the drawing, the preferred embodiment of the system and method for a payment transaction in accordance with the present invention is illustrated by FIG. 1. As shown in FIG. 1, the preferred system and method for a payment transaction is adapted to permit a payee to receive a payment from a payor without generating an account prior to receiving a payment from a payor (or “payer”) and permit the payor to direct payments to a payment account that the payor generates. The preferred system and method for a payment transaction is also adapted to effect a payment transaction without the payee providing the payor with sensitive information the payee may not want to provide (e.g. payee's Social Security No.) or information that must be updated from time to time (e.g. payee's residential address). The preferred system and method for a payment transaction also does not require the payor to collect an undesirably burdensome amount of routing and account information from the payee in order to make a payment to the payee's account. Further, the preferred system and method for a payment transaction does not limit the payee's ability to receive a payment from a payor based on the payee's ability to access the designated account and permits the payee to self-direct the payment. Still further, the preferred system and method for a payment transaction does not limit the form of payment the payee may receive. In addition, the preferred system and method for a payment transaction allows the payor to generate a payment account for each payee. The preferred system and method for a payment transaction is also transparent with respect to the transaction history of the payment and the spending patterns of the payee. Further, the preferred system and method for a payment transaction minimizes or eliminates cash flow and reconciliation difficulties. Still further, the preferred system and method for a payment transaction is less expensive and faster and generates revenue for the payment processor.

Referring now to FIG. 1, a flow chart of the preferred embodiment of the system and method for a payment transaction is illustrated. As shown in FIG. 1, the preferred system and method for a payment transaction is designated generally by reference numeral 20. Preferred system and method for a payment transaction 20 is adapted to facilitate a payment from a payor (or “payer”) 22 to a payee 24. Preferred payor 22 is an insurer, a reinsurer, or a third-party administrator, but it is also contemplated within the scope of the invention that the payor may be any suitable individual or business entity. Preferred payee 24 may be an individual or business entity. Preferred system and method for a payment transaction 20 comprises payor (or “payer”) portal 30 which is adapted to be accessed by payor 22 and which is managed by payment processor 34 as described in more detail below. More particularly, payor 22 accesses payor portal 30 to generate payment account 40. While the preferred system and method for a payment transaction includes payor portal 30, it is contemplated within the scope of the invention that payor 22 may generate a payment account via file transfer protocol, application programming interface, and the like.

Still referring to FIG. 1, preferred payment account 40 is an electronic payment account that is unique to each payee 24. Preferred payment account 40 is adapted to receive a payment from payor 22 and transfer a payment to the payee in at least one form of payment. Preferably, payor 22 uses payee 24 information to generate payment account 40 and the payment account will reside in exemplary issuing bank 50. After payment account 40 is successfully generated, payor 22 will preferably receive confirmation of the payment account from payment processor 34. Also after payment account 40 is successfully generated, payee 24 will preferably receive an enrollment notification from payment processor 34 via email, text message, telephone call and/or any other suitable communication means. It is contemplated within the scope of the invention that payor 22 will pay a fee to payment processor 34 in connection with the generation of payment account 40 and that the payment processor will process any such fee. While FIG. 1 illustrates the preferred system and method for generating a payment account, it is contemplated within the scope of the invention that the payment account may be generated by any suitable system and method.

Still referring to FIG. 1, after payment account 40 is successfully generated, payor 22 will preferably transmit payee's payment using a file transfer protocol or application programming interface managed by payment processor 34. Preferably, payment processor 34 will process payor's payment and process the settlement of payor's payment to payment account 40. In addition, payment processor 34 will preferably manage and verify the payor's payment. Optionally, the payment remitted by payor 22 will be reviewed and approved by payment processor 34. After the payor's payment is processed and/or approved by payment processor 34, the payment processor will transmit the payment balance to payment account 40, process the settlement and make an ACH (automated clearing house) request to funding account 60. The payment will then preferably be conveyed from funding account 60 to a fund holding account such as FBO (for the benefit of) account 70. Preferred FBO account 70 is adapted to provide a payment to payment account 40. Preferred FBO account 70 will reside at the same issuing bank as payment account 40.

While it is contemplated within the scope of the invention that preferred funding account 60 and preferred FBO account 70 may hold funds in excess of the payment owed by payor 22 to payee 24, preferred payment account 40 is adapted to hold only the amount of the payment owned by the payor to the payee. In addition, if the payor's payment is processed or approved by payment processor 34, payor 22 will preferably receive confirmation from the payment processor and payee 24 will preferably receive a verification receipt from the payment processor. Still further, if the payor's payment is processed or approved by payment processor 34, the payment processor will provide a report to payor 22 which will allow the payor to, inter alia, reconcile the payment. It is contemplated within the scope of the invention that payor 22 may provide procedural authorization, either manually or electronically, of a transfer of a payment into payment account 40 and/or FBO account 70. It is also contemplated within the scope of the invention that payor 22 will pay a fee to payment processor 34 in connection with the transmittal of the payment to payment account 40 and/or FBO account 70 and that the payment processor will process any such fee. While FIG. 1 illustrates the preferred system and method for sending a payment to a payment account, it is contemplated within the scope of the invention that a payment may be sent to a payment account by any suitable system or method.

Still referring to FIG. 1, after preferred FBO account 70 receives the payment from funding account 60, payment processor 34 processes the funds from payment account 40 to payee 24.

Preferred payment account 40 is adapted to provide the payment to payee 24 in at least one form of payment. Preferably, payment account 40 is a dedicated account for only payee 24 and allows the payee to self-direct the transfer of the payment from the payment account and control the form of payment made from the payment account. More particularly, in preferred system and method for a payment transaction 20, payee 24 accesses payee portal 80 which allows the payee to self-direct the transfer of the payment from payment account 40 to the payee. It is contemplated within the scope of the invention that payee 24 may access payment account 40 via the Internet, mobile device, telephone, or any other suitable means. Preferably, payee 24 can self-direct the transfer of the payment from payment account 40 at any time. Also in preferred system and method for a payment transaction 20, payee 24 can self-direct the transfer of the payment from payment account 40 without any communication with payor 22. Further, in the preferred system and method for a payment transaction 20, the form of payment available to payee 24 includes, without limitation, cash, check, money order, pre-paid card, MoneyGram, bill payment, external account, and virtual pre-paid account.

It is also contemplated within the scope of the invention that payee 24 may self-direct only a portion of the payment at a time and may self-direct portions of the payment in different forms of payment. It is further contemplated within the scope of the invention that payment processor 34 provides transactional information and reports to payee 24 through payee portal 80. It is still further contemplated within the scope of the invention that payment processor 34 may provide authorizations for electronic purchase transactions against balances on payment account 40 and/or FBO account 70. In addition, it is contemplated within the scope of the invention that payee 24 or payor 22 will pay a fee to payment processor 34 in connection with the self-direction of the payment and that the payment processor will process any such fee. It is also contemplated within the scope of the invention that payment processor 34 will receive interchange income from a point-of-sale signature or PIN transaction. While FIG. 1 illustrates the preferred system and method for self-directing a payment from a payment account, it is contemplated within the scope of the invention that a payment from a payment account may be self-directed by any suitable system or method.

The system and method for a payment transaction also comprises a method for facilitating a payment transaction from a payor to a payee. The preferred method comprises providing a system for facilitating a payment from a payor to a payee. The preferred system comprises a payment account that is generated by the payor and adapted to receive the payment from the payor and transfer the payment to the payee in at least one form of payment, a funding account that is adapted to provide funds to a fund holding account which is adapted to provide the payment to the payment account, a payment processor that is adapted to process the payment from the payor to the payment account and process the payment from the payment account to the payee, and a payee portal that is adapted to be accessed by the payee and receive the payment from the payment account. Preferably, the payment account is a dedicated account for only the payee, and the payee self-directs the transfer of funds from the payment account and controls the form of payment made from the payment account. Preferably, the forms of payment made from the payment account include, without limitation, cash, check, money order, pre-paid card, MoneyGram, bill payment, external account, and virtual pre-paid account. The preferred method also comprises generating a payment account, providing funds to the payment account and self-directing funds from the payment account.

Also in the preferred embodiments of the method for facilitating a payment transaction from a payor to a payee, the method further comprises generating a fee paid by the payee or the payor to the payment processor and generating an interchange income. The preferred method still further comprises self-directing funds from the payment account at any time and self-directing funds from the payment account without any communication between the payee and the payor. In addition, the preferred method comprises managing, reporting, and authorizing the payment from the payor to the payee. The preferred method also comprises accessing the payment account via the Internet.

In operation, several advantages of the preferred embodiments of the system and method for a payment transaction are achieved. For example, the preferred embodiments of the system and method for a payment transaction permit payees who do not have traditional financial institution accounts to receive payments from a payor. The preferred embodiments of the system and method for a payment transaction also permit payments to be easily and promptly made to payees under otherwise impossible circumstances such as natural disasters and the like. The preferred embodiments of the system and method for a payment transaction further permit a payor to reduce its cost of making payments to payees and provides an opportunity to generate fees for such payment transactions. The preferred embodiments of the system and method for a payment transaction still further provide the payor with additional information including transaction history and payment trends and minimize cash flow and reconciliation problems.

Although this description contains many specifics, these should not be construed as limiting the scope of the invention but as merely providing illustrations of some of the presently preferred embodiments thereof, as well as the best mode contemplated by the inventors of carrying out the invention. The invention, as described herein, is susceptible to various modifications and adaptations, and the same are intended to be comprehended within the meaning and range of equivalents of the appended claims.

What is claimed is:

1.-20. (canceled)

21. A system, comprising:
a payor portal that provides a Web-based interface that allows a first payor entity to set up an account dedicated to a first payee entity by providing a subset of first payee entity identification information, the first payee entity different from the first payor entity, the payor portal which causes a notification to be provided electronically to the first payee entity, and which provides a notification to the first payor entity when the account for the first payee entity has been set up, and which funds the account set up for the first payee entity with a payment from the first payor entity; and
a payee portal that provides a Web-based interface that allows at least the first payee entity to self-direct transfers from the account set up for the first payee entity by the first payor entity.

22. The system of claim 21, further comprising:
a payment processor system that processes payments from the first payor entity to the account dedicated to the first payee entity.

23. The system of claim 22 wherein the payment processor system further processes transfers the self-directed transfers from the account dedicated to the first payee entity.

24. The system of claim 23 wherein the payment processor system further causes funds to be provided to a funding account.

25. The system of claim 24 wherein the payment processor system further causes funds to be credited to a fund holding account for the benefit of the first payee entity, the fund holding account and the account dedicated to the first payee entity residing at a same issuing bank as one another.

26. The system of claim 21 wherein the payee portal allows the first payee entity to self-direct transfers from the account set up for the first payee entity by the first payor entity without any further communication by the first payor entity.

27. The system of claim 21 wherein the payee portal provides the first payee entity self-directed transfer options including each of: a cash payment, a check, a money order, a prepaid card, a bill payment, an external account, and a virtual prepaid account.

28. The system of claim 21 wherein the payment processor system is communicatively coupled to receive payments from the first payee entity via at least one of: a file transfer protocol (FTP) transaction or an application programming interface (API) call.

29. The system of claim 28 wherein a payment by the first payor entity to the first payee entity is managed and reported by the payment processor system.

30. The system of claim 21 wherein the Web-based interface that allows a first payor entity to set up an account dedicated to a first payee entity by providing a subset of first payee entity identification information, allows the first payor entity to set up the account dedicated to the first payee entity without sensitive information of the first payee entity including without a social security number of the first payee entity and without information of the first payee entity that needs to be updated from time-to-time including a physical address of the first payee entity, and without requiring the first payor entity to supply either routing or account information of the first payee entity.

31. A method, comprising:
providing, by a payor portal, a Web-based interface that allows a first payor entity to set up an account dedicated to a first payee entity by providing a subset of first payee entity identification information, the first payee entity different from the first payor entity;
causing, by the payor portal, a notification to be provided electronically to the first payee entity of the setting up of the account dedicated to the first payee entity by the first payor entity;
causing, by the payor portal, a notification to the first payor entity when the account for the first payee entity has been set up;
funding, by the payor portal, the account set up for the first payee entity with a payment from the first payor entity; and
providing, by a payee portal, a Web-based interface that allows at least the first payee entity to self-direct transfers from the account set up for the first payee entity by the first payor entity.

32. The method of claim 31, further comprising:
processing payments, by a payment processor system, from the first payor entity to the account dedicated to the first payee entity.

33. The method of claim 32, further comprising:
processing, by the payment processor system, the self-directed transfers from the account dedicated to the first payee entity.

34. The method of claim 33, further comprising:
causing, by the payment processor system, funds to be provided to a funding account.

35. The method of claim 34, further comprising:
causing, by the payment processor system, funds to be credited to a fund holding account for the benefit of the first payee entity, the fund holding account and the account dedicated to the first payee entity residing at a same issuing bank as one another.

36. The method of claim 31 wherein providing a Web-based interface that allows at least the first payee entity to self-direct transfers from the account set up for the first payee entity by the first payor entity includes providing a Web-based interface that allows at least the first payee entity to self-direct transfers from the account set up for the first payee entity by the first payor entity without any further communication by the first payor entity.

37. The method of claim 31 wherein providing a Web-based interface that allows at least the first payee entity to self-direct transfers from the account set up for the first payee entity by the first payor entity includes providing a Web-based interface that allows at least the first payee entity to self-direct transfers from the account set up for the first payee entity by the first payor entity via each of: a cash payment, a check, a money order, a prepaid card, a bill payment, an external account, and a virtual prepaid account.

38. The method of claim 31, further comprising:
receiving, by the payment processor system, payments from the first payee entity via at least one of: a file transfer protocol (FTP) transaction or an application programming interface (API) call.

39. The method of claim 38, further comprising:
managing, by the payment processor system, a payment by the first payor entity to the first payee entity; and
reporting, by the payment processor system, the payment.

40. The method of claim 31 wherein providing a Web-based interface that allows a first payor entity to set up an account dedicated to a first payee entity by providing a subset of first payee entity identification information, includes providing a Web-based interface that allows the first payor entity to set up the account dedicated to the first payee entity without sensitive information of the first payee entity including without a social security number of the first payee entity and without information of the first payee entity that needs to be updated from time-to-time including a physical address of the first payee entity, and without requiring the first payor entity to supply either routing or account information of the first payee entity.
